(19) United States
(12) Patent Application Publication
(10) Pub. No.: US 2024/0304035 A1
(43) Pub. Date: Sep. 12, 2024

(54) SYSTEM AND METHOD FOR CENTRALIZED COLLECTION OF VEHICLE-DETECTED EVENT DATA

(71) Applicant: WOVEN BY TOYOTA, INC., Tokyo (JP)

(72) Inventor: Ho Ki Wilson LAM, Tokyo (JP)

(73) Assignee: WOVEN BY TOYOTA, INC., Tokyo (JP)

(21) Appl. No.: 18/179,454

(22) Filed: Mar. 7, 2023

(51) Int. Cl. G07C 5/00; G01S 17/89; G06T 7/50; G07C 5/08

(52) U.S. Cl. CPC G07C 5/008; G01S 17/89; G06T 7/50; G07C 5/0841; G06T 2207/10048

(57) ABSTRACT

Provided are method, system, and device for collecting data associated with an event from vehicles. The method may be implemented by programmed one or more processors in a server for collecting evidence to investigate an event, and may include: obtaining a time and a location for the event to be investigated; transmitting a signal including the time and the location for requesting sensor data corresponding to the event from a plurality of vehicles; receiving the sensor data corresponding to the event from at least one of the plurality of vehicles; and providing the received sensor data for investigating the event.

### TECHNICAL FIELD

Systems, methods, and devices consistent with example embodiments of the present disclosure relate to vehicles, and more particularly, relate to systems, methods, and devices for collecting event data from vehicles and managing said event data thereafter.

### BACKGROUND

Typically, events such as crimes, accidents, and other such incidents that require investigation are examined using data collected from the scene as evidence. For instance, a hit-and-run incident may be investigated using data collected by security cameras or surveillances deployed nearby the incident, a car accident may be investigated using data collected by the on-board sensors, and the like.

The source of such evidence or data, however, may be limited, particularly in remote areas, rural areas, or other areas that do not have operational surveillance or security cameras, or in incidents involving vehicles that are not equipped with on-board sensors and/or persistent sensor data storages.

Further, even for incidents that are captured by one or more sensors, it may often be the case that the captured data is from a perspective, line of sight, and the like, that cannot paint a complete picture. For example, an accident involving two vehicles may appear to be the fault of one particular vehicle based on public surveillance or traffic camera data, though in reality the other vehicle may have caused the accident by some illegal behavior (e.g., an illegal U-turn) that is outside the capture area of the camera. In these cases, investigating incidents (such as crimes or accidents) is hindered by a lack of evidence.

### SUMMARY

According to embodiments, methods, systems and devices are provided for crowdsourcing data from a plurality of vehicles equipped with onboard sensors. Accordingly, a larger amount and more robust event data may be collected.

According to embodiments, a method, implemented by programmed one or more processors in a server, for collecting evidence to investigate an event is provided, the method may include: obtaining a time and a location for the event to be investigated; transmitting a signal including the time and the location for requesting sensor data corresponding to the event from a plurality of vehicles; receiving the sensor data corresponding to the event from at least one of the plurality of vehicles; and providing the received sensor data for investigating the event.

The time may include a time range corresponding to the event and/or the location may include a location range corresponding to the event. The sensor data may include at least one of image data, LiDAR sensor data, accelerometer data, audio data, and infrared image data captured by onboard sensors of the vehicle.

The receiving the sensor data may include receiving the sensor data from another server that anonymizes the sensor data.

The method may further include: processing the received sensor data, wherein the received sensor data may include infrared image data, and wherein the processing the received sensor data may include determining whether the infrared image data includes a shape of an object with a temperature greater than a predetermined threshold.

The method may further include: processing the received sensor data, wherein the received sensor data may include LiDAR sensor data, and wherein the processing the received sensor data may include determining whether the event is captured based on the LiDAR sensor data.

The method may further include: performing, on the received sensor data, one or more of: pre-processing, converting, collating, and filtering.

According to embodiments, a system for collecting evidence to investigate an event is provided, the system may include: a memory storing instructions; and at least one programmed processor configured to execute the instructions to: obtain a time and a location for the event to be investigated; transmit a signal including the time and the location for requesting sensor data corresponding to the event from a plurality of vehicles; receive the sensor data corresponding to the event from at least one of the plurality of vehicles; and provide the received sensor data for investigating the event.

The time may include a time range corresponding to the event and/or the location may include a location range corresponding to the event. The sensor data may include at least one of image data, LiDAR sensor data, accelerometer data, audio data, and infrared image data captured by onboard sensors of the vehicle.

The receiving the sensor data may include receiving the sensor data from another server that anonymizes the sensor data.

The at least one programmed processor may be further configured to execute the instructions to: process the received sensor data, wherein the received sensor data may include infrared image data, and wherein the processing the received sensor data may include determining whether the infrared image data includes a shape of an object with a temperature greater than a predetermined threshold.

The at least one programmed processor may be further configured to execute the instructions to: process the received sensor data, wherein the received sensor data may include LiDAR sensor data, and wherein the processing the received sensor data may include determining whether the event is captured based on the LiDAR sensor data.

The at least one programmed processor may be further configured to execute the instructions to perform, on the received sensor data, one or more of: pre-processing, converting, collating, and filtering.

According to embodiments, a non-transitory computer-readable recording medium is provided, the non-transitory computer-readable recording medium may have recorded thereon instructions executable by at least one programmed processor to cause the at least one programmed processor to perform a method for collecting evidence to investigate an event, the method may include: obtaining a time and a location for the event to be investigated; transmitting a signal including the time and the location for requesting sensor data corresponding to the event from a plurality of vehicles; receiving the sensor data corresponding to the event from at least one of the plurality of vehicles; and providing the received sensor data for investigating the event.

The time may include a time range corresponding to the event and/or the location may include a location range corresponding to the event. The sensor data may include at least one of image data, LiDAR sensor data, accelerometer data, audio data, and infrared image data captured by onboard sensors of the vehicle.

The receiving the sensor data may include receiving the sensor data from another server that anonymizes the sensor data.

The non-transitory computer-readable recording medium may have recorded thereon instructions executable by the at least one programmed processor to cause the at least one programmed processor to perform the method that may further include: processing the received sensor data, wherein the received sensor data may include infrared image data, and wherein the processing the received sensor data may include determining whether the infrared image data includes a predetermined with a temperature greater than a predetermined threshold.

The non-transitory computer-readable recording medium may have recorded thereon instructions executable by the at least one programmed processor to cause the at least one programmed processor to perform the method that may further include: processing the received sensor data, wherein the received sensor data may include LiDAR sensor data, and wherein the processing the received sensor data may include determining whether the event is captured based on the LiDAR sensor data.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like reference numerals denote like elements, and wherein:

FIG. 1 illustrates a block diagram of an example system for communicating with one or more vehicles, according to one or more embodiments;

FIG. 2 illustrates a diagram of example components of a server, according to one or more embodiments;

FIG. 3 illustrates a flow diagram of an example method for collecting data to investigate an event, according to one or more embodiments;

FIG. 4 illustrates a diagram of example components of a vehicle, according to one or more embodiments;

FIG. 5 illustrates an example of a record file, according to one or more embodiments; and

FIG. 6 illustrates a flow diagram of an example method for providing data to investigate an event, according to one or more embodiments.

### DETAILED DESCRIPTION

The following detailed description of exemplary embodiments refers to the accompanying drawings. The foregoing disclosure provides illustration and description but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,”“have,”“having,”“include,”“including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,”“an embodiment,”“non-limiting exemplary embodiment,” or similar language means that a particular feature, structure, or characteristic described in connection with the indicated embodiment is included in at least one embodiment of the present solution. Thus, the phrases “in one embodiment”, “in an embodiment,”“in one non-limiting exemplary embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

In one implementation of the disclosure described herein, a display page may include information residing in the computing device's memory, which may be transmitted from the computing device over a network to a database center and vice versa. The information may be stored in memory at each of the computing device, a data storage resided at the edge of the network, or on the servers at the database centers. A computing device or mobile device may receive non-transitory computer readable media, which may contain instructions, logic, data, or code that may be stored in persistent or temporary memory of the mobile device, or may somehow affect or initiate action by a mobile device. Similarly, one or more servers may communicate with one or more mobile devices across a network, and may transmit computer files residing in memory. The network, for example, can include the Internet, wireless communication network, or any other network for connecting one or more mobile devices to one or more servers.

Examples embodiments of the present disclosure provides a method, a system, and a device for crowdsourcing data from a plurality of vehicles equipped with onboard sensors. Accordingly, a larger amount and more robust data may be collected. For instance, a larger amount and more trustworthy or unbiased evidences corresponding to an event or an incident can be obtained, and the event/incident may be investigated and be eased based thereon.

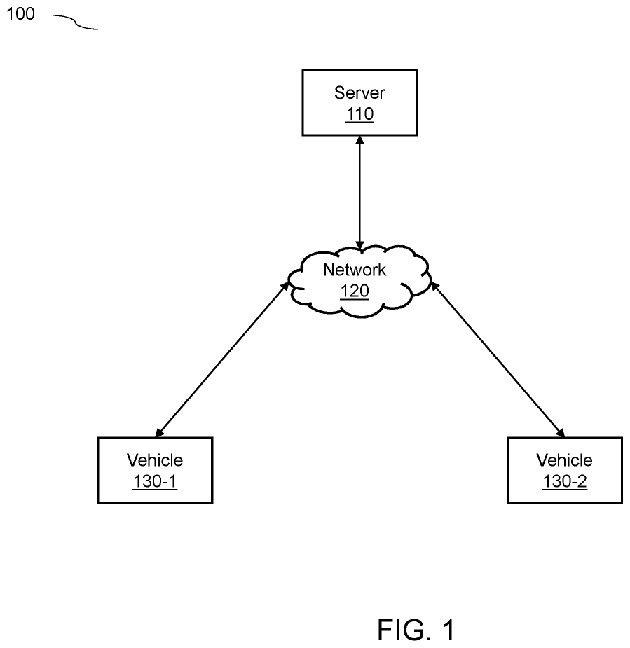

FIG. 1 illustrates a block diagram of an example system 100 for communicating with one or more vehicles, according to one or more embodiments. Referring to FIG. 1, system 100 may include a server 110, a network 120, and a plurality of vehicles (vehicle 130-1 and 130-2).

The server 110 may be communicatively coupled to the plurality of vehicles via the network 120. The server 110 and the plurality of vehicles may be configured to transmit and to receive one or more information to-and-from one another. The information may be exchanged among the server 110 and the plurality of vehicles in the form of signal, network data, and any other suitable form.

Network 120 may include one or more data links that enable the transport of electronic data between the server 110 and the plurality of vehicles (and the components or systems included therein). In this regard, network 120 may include one or more wired and/or wireless networks. For example, network 120 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a Wireless Fidelity (WiFi) network, a private network, a Bluetooth™ network, an ad hoc network, an intranet, the Internet, a fiber optic-based network, or the like, and/or a combination of these or other types of networks. According to embodiments, the server 110 may be configured to broadcast or multicast an inquiry or a signal including information of an event (e.g., a crime, an accident, etc.). The inquiry/signal may be transmitted to the plurality of vehicles via an over-the-air (OTA) transmission using network 120.

The server 110 may include one or more devices capable of receiving, generating, storing, processing, computing, and/or providing information or data. According to embodiments, server 110 may include a cloud server or a group of cloud servers (e.g., server cluster, etc.). According to embodiments, server 110 may be constituted by a plurality of servers, a portion of which may be deployed in different locations. For instance, server 110 may include: an edge server deployed nearby the vehicle 130-1 and/or the vehicle 130-2, a central server deployed further from the vehicle 130-1 and/or the vehicle 130-2, and the like.

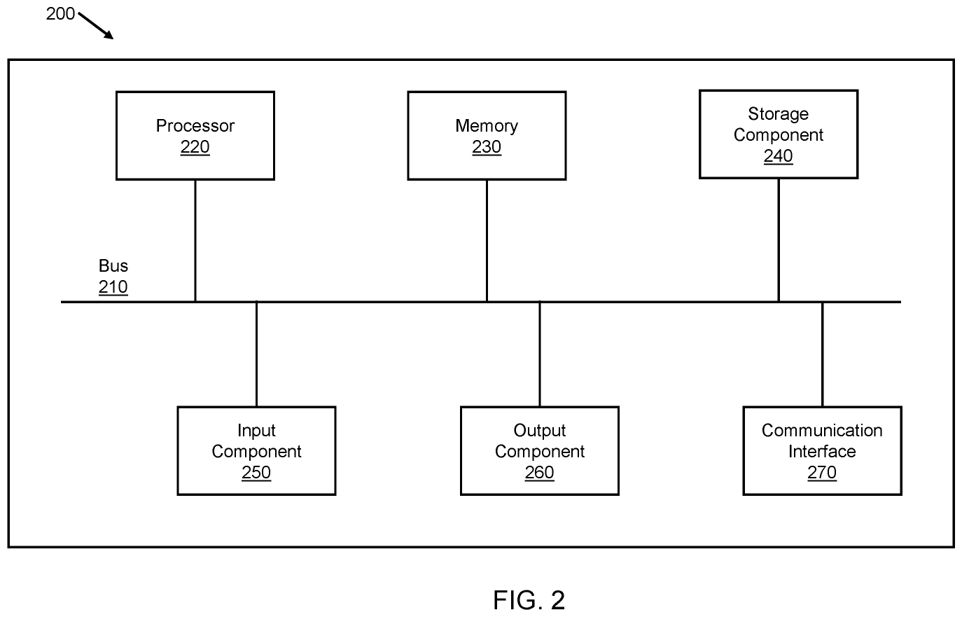

FIG. 2 illustrates a diagram of example components of a server 200, according to one or more embodiments. Server 200 may be similar to server 110 in FIG. 1, thus the descriptions associated with server 200 and server 110 may be applicable to each other, unless being explicitly described otherwise.

Referring to FIG. 2, the server 200 may include a bus 210, a processor 220, a memory 230, a storage component 240, an input component 250, an output component 260, and a communication interface 270.

Bus 210 may include one or more components that permit communication among the components of server 200. Processor 220 may be implemented in hardware, firmware, or a combination of hardware and software. Processor 220 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing or computing component. In some implementations, processor 220 may include one or more processors capable of being programmed to perform a function. Memory 230 may include a random access memory (RAM), a read only memory (ROM), and/or another type of dynamic or static storage device (e.g., a flash memory, a magnetic memory, and/or an optical memory) that stores information and/or instructions for use by processor 220.

Storage component 240 may store information and/or software related to the operation and use of server 200. For example, storage component 240 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 250 may include one or more components that permit the server 200 to receive information, such as via user input (e.g., a touch screen display, a keyboard, a keypad, a mouse, a button, a switch, and/or a microphone). Additionally, or alternatively, input component 250 may include a sensor for sensing information (e.g., a global positioning system (GPS) component, an accelerometer, a gyroscope, and/or an actuator). Output component 260 may include one or more components that provide output information from the server 200 (e.g., a display, a speaker, and/or one or more light-emitting diodes (LEDs)).

Communication interface 270 may include a transceiver-like component (e.g., a transceiver and/or a separate receiver and transmitter) that enables the server 200 to communicate with other devices, such as via a wired connection, a wireless connection, or a combination of wired and wireless connections. Communication interface 270 may permit server 200 to receive information from another device (e.g., device included in the plurality of vehicles, etc.) and/or provide information to said another device. For example, communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

Server 200 may perform one or more processes described herein in response to processor 220 executing software instructions stored by a non-transitory computer-readable recording medium, such as memory 230 and/or storage component 240. A computer-readable medium is defined herein as a non-transitory memory device. A memory device may include memory space within a single physical storage device or memory space spread across multiple physical storage devices.

Software instructions may be read into memory 230 and/or storage component 240 from another computer-readable medium or from another device via communication interface 270. When executed, software instructions stored in memory 230 and/or storage component 240 may cause processor 220 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

According to one or more embodiments, the server 200 may be configured to perform a method for collecting data from one or more vehicles. The data may be utilized as evidence to investigate an event (e.g., a crime, an accident, etc.). Alternatively, the data may be utilized for other purposes, such as map making, historical logging, and the like.

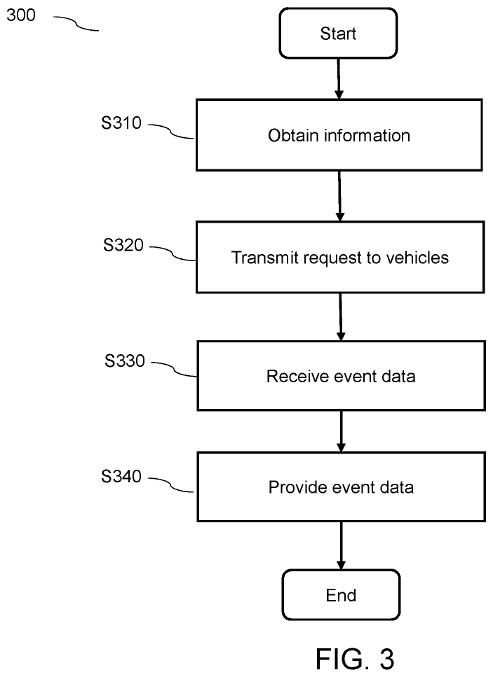

FIG. 3 illustrates a flow diagram of an example method 300 for collecting data to investigate an event, according to one or more embodiments. One or more operations of method 300 may be performed by a server (e.g., server 110 in FIG. 1, server 200 in FIG. 2, etc.). For instance, the server may configured to receive or obtain information associated with the event, to request the associated vehicle(s) to provide data associated with the event (may be referred to as “event data” herein), to receive the event data from the associated vehicles, and to provide the event for investigating the event.

Referring to FIG. 3, at operation S310, information associated with the event is obtained or received. For instance, one or more processors of the server (e.g., processor 220, etc.) may be configured to obtain or receive a request (via a communication interface of the server (e.g., communication interface 270, etc.)) from one or more devices or systems (e.g., a user equipment of an event investigator, an event investigation system, another server, etc.) communicatively coupled to the server (e.g., directly coupled to server via wired connection, indirectly coupled to server via wireless connection, etc.). Alternatively or additionally, the one or more processors may be configured to obtain or receive the request directly via an input component of the server (e.g., input component 250, etc.) from a user (e.g., event investigator, system operator, etc.).

According to embodiments, the request may include information associated with the event, such as a location of the event, a time of the event, a type of the event, and the like. In this regard, the location of the event may include a particular latitude and longitude or a location range corresponding to the event, or the like, the time of the event may include a specific time point or a time range corresponding to the event, and the type of the event may include a category (e.g., crime, accident, etc.) and a sub-category (e.g., car accident, hit-and-run incident, etc.) corresponding to the event.

According to other embodiments, the server may be configured to determine or derive the required information (e.g., location of the event, time of the event, etc.) from the request. For instance, the request may include a report of the event (e.g., written report, voice recording, etc.), and the one or more processors may perform keyword extraction (e.g., text recognition, voice processing, etc.) or other suitable operation(s) to determine or extract the required information from the report.

Subsequently, at operation S320, the server may be configured to communicate with one or more vehicles to request data associated with the event therefrom. According to embodiments, the server may determine the one or more vehicles associated with the event and may transmit a signal including the information of the event (e.g., the time of the event, the location of the event, etc.) for requesting data corresponding to the event from the one or more vehicles. According to embodiments, the request may be a request for sensor data collected via one or more sensors deployed in the one or more vehicles.

In this regard, the one or more processor may determine, based on the location of the event and/or the time of the event, one or more vehicles located within an area of the event during the time of the event, and may transmit the request to said one or more vehicles via a network (e.g., network 120, etc.). As another example, the one or more processor may determine (e.g., based on information stored in one or more storage mediums such as the memory 230 and/or the storage component 240, etc.) one or more vehicles registered in the system or for whose owners have consented to participate in the data collection process, and may transmit the request to said one or more vehicles. As yet another example, the one or more processors may determine one or more vehicles within a particular range from one or more active networks or one or more vehicles which are connecting to one or more particular networks, and may transmit the request to said one or more vehicles.

Upon transmitting the request, at operation S330, the server may receive the requested event data from the one or more vehicles. For instance, the server may receive (via the communication interface, etc.) the requested event data from the one or more vehicles, and/or from one or more devices associated with said vehicles (e.g., one or more servers associated with said vehicle(s), one or more external storage mediums associated with said vehicle(s), etc.). According to embodiments, the received event data may include sensor data. For instance, the received event data may include image data, LiDAR sensor data, accelerometer data, audio data, infrared image data, and/or any other suitable sensor data, captured by one or more onboard sensors of the one or more vehicles.

The received event data may be stored to one or more storage mediums (e.g., memory 230, storage component 240, etc.). According to embodiments, the server may be configured to process a portion or all of the received event data before and/or after storing the received event data to the one or more storage mediums.

For instance, the one or more processors may be configured to perform one or more of the following operations to the portion or all of the received event data: pre-processing (e.g., normalizing, encoding, decoding, enriching, etc.), converting (e.g., speech-to-text and/or natural language understanding for audio data), collating (e.g., cataloging, etc.), and filtering (e.g., excluding a portion of the data by detecting or classifying particularly objects or by comparing a threshold against a threshold (e.g., a threshold volume level for captured audio data), etc.).

Further, the one or more processors may be configured to anonymize a portion of or all of the received event data. For instance, the one or more processors may be configured to determine which of the received event data is required to be anonymize (e.g., indicia of the vehicle or user of the vehicle, sensitive information such as travel history of the vehicle, etc.), and to perform one or more suitable data anonymizations (e.g., erasing, encrypting, etc.) on said data.

According to embodiments, the one or more processors may perform on or more of the aforesaid operations via utilizing one or more artificial intelligence (AI) models or machine learning (ML) models (e.g., input at least a portion of the received event data to one or more AI/ML models trained to performed the aforesaid operations, etc.). The one or more AI/ML models may be pre-trained and be stored in the one or more storage mediums, and may be retrieved and utilized by the one or more processors when required. According to embodiments, in addition to utilizing the one or more AI/ML models to perform the aforesaid operation(s), the one or more processors may also train the one or more AI/ML models with the received event data.

Furthermore, the one or more processors may also utilize one or more AI/ML models and/or one or more rule-based algorithms to detect relevancy of the received event data to a corresponding event. For instance, where the received event data is audio data, the one or more processors may determine whether the audio data includes a predetermined keyword or is louder than a predetermined threshold. Further, where the received event data is infrared image data and the event involves a particular object (e.g., another vehicle, a nearby building, etc.) being on fire, the one or more processors may determine whether the infrared image data includes a shape of that particular object with a temperature greater than a predetermined threshold. Furthermore, where the received event data includes LiDAR sensor data, the one or more processors may determine whether that event is captured by the vehicle (e.g., whether there is a collision between a vehicle and a pedestrian where the event is a vehicular assault or homicide, etc.) based on the LiDAR sensor data.

Accordingly, at operation S340, the server may provide the received event data for investigating the event. For instance, the one or more processors may provide the processed data to one or more devices or systems (e.g., a user equipment of an event investigator, an event investigation system, another server, etc.) via the communication interface, may provide the processed data to the user (e.g., event investigator, etc.) via an output component (e.g., output component 260, etc.), and/or the like. According to embodiments, upon processing the data, the one or more processors may store the processed data to the one or more storage mediums, and said processed data may be retrieved or provided for investigating the event upon requested.

It can be understood that, at operation S340, the server may also simply provide a portion or all of the received event data for investigating the event, without processing the received data. For instance, the received event data may already be processed by the one or more vehicles and/or the associated devices (e.g., a processing server associated with the vehicle, an external storage medium associated with the vehicle, etc.), and/or is not required to be further processed by the server 200. By way of an example, the event data may be provided by one or more servers associated with the vehicle(s) that anonymize the event data, and the server may simply receive the event data from said one or more servers. In that case, upon receiving the event data at operation S330, the server may initiate operation S340 without processing the received event data.

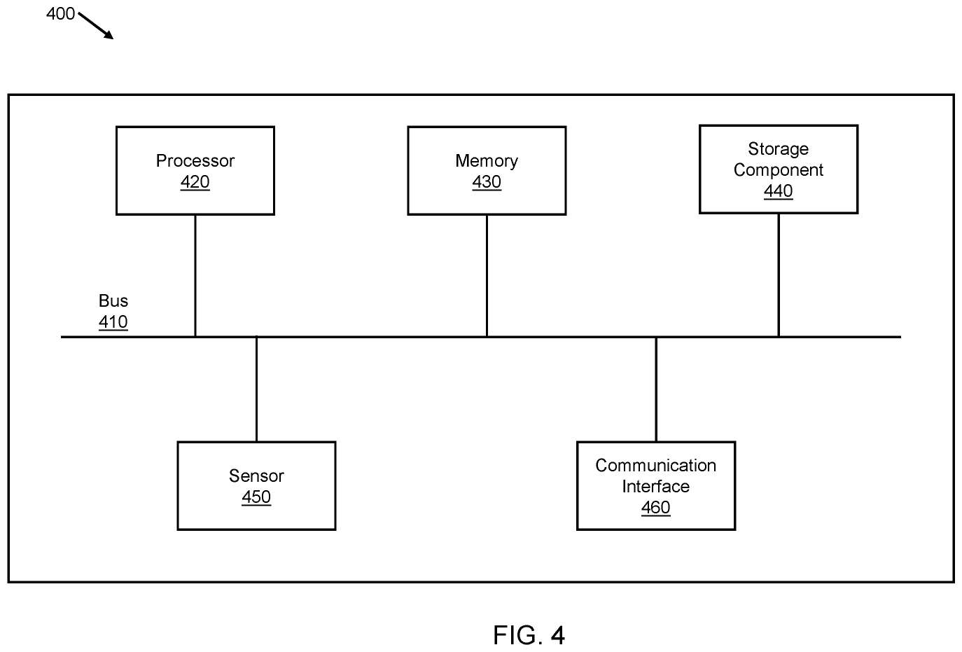

FIG. 4 illustrates a diagram of example components of a vehicle 400, according to one or more embodiments. Vehicle 400 may be similar to vehicle 130-1 and/or vehicle 130-2 in FIG. 1, thus the descriptions associated with vehicle 400 and vehicle 130-1/vehicle 130-2 may be applicable to each other, unless being explicitly described otherwise.

Further, vehicle 400 may include any motorized and/or mechanical machine which may carry or transport people and/or cargo, such as: a car, a truck, a motorcycle, a bus, a bicycle, a mobility scooter, an aerial vehicle, and the like.

Referring to FIG. 4, vehicle 400 may include a bus 410, a processor 420, a memory 430, a storage component 440, a sensor 450, and a communication interface 460. The general functions and roles of the bus 410, the processor 420, the memory 430, the storage component 440, and the communication interface 460 may be similar to the bus 210, the processor 220, the memory 230, the storage component 240, and the communication interface 270, respectively, described above with reference to FIG. 2. Thus, redundant descriptions associated therewith may be omitted herein for conciseness. Further, it can be understood that vehicle 400 may also include input component and output component having a similar functions and role of input component 250 and output component 260, without departing from the scope of the present disclosure.

Referring to FIG. 4, vehicle 400 may include at least one sensor 450 configured to detect, measure, and capture respective data (may be referred to as “sensor data” herein). For instance, the at least one sensor 450 may include: an accelerometer which measures and captures data associated with the acceleration/deceleration of the vehicle, the vehicle speed, and/or the vehicle travel distance; an image sensor (e.g., camera, etc.) which detects and captures image data surrounding or nearby the vehicle; a light detection and ranging (LiDAR) sensor which detects and captures data associated with light in one or more light spectrums, such as the visible spectrum, the infrared spectrum, the ultraviolet spectrum, and/or any other light spectrums; an audio sensor (e.g., microphone, etc.) which may detect and capture audio data internal and/or external to the vehicle; a temperature sensor which measures and captures data associated with temperature internal and/or external to the vehicle; a location sensor (e.g., global positioning system (GPS), inertial measurement unit (IMU), etc.) which measures and captures data associated with the location, position, and/or orientation of the vehicle; a contact sensor (e.g., pressure detector, impact detector, etc.) which detects and captures data between a portion of the vehicle and an object; an air sensor which measures and captures data associated with the air (e.g., oxygen level, pollution level, humidity level, etc.) internal and/or external to the vehicle; and any other sensors suitable to be deployed in the vehicle.

It can be understood that a portion of the aforementioned sensors may operate with each other to perform a specific operation. For example, the accelerometer and the location sensor may interoperate to measure a current position of the vehicle and to estimate an upcoming position of the vehicle, the image sensor may interoperate with the audio sensor to produce a video recording file, the location sensor may provide position information and timing information to each of the aforesaid sensors such that the data measured/captured by said sensors may be mapped to a corresponding location and time where and when it is measured/captured, and the like.

Further, the at least one sensor 450 may be internet-of-things (IoT) based, which enables the vehicle to communicate with another device via a network. For instance, the vehicle may communicate with one or more external storage mediums to store the measured sensor data therein, may communicate with a server to provide a portion or all of the measured sensor data for anonymization, may communicate with a server (e.g., server 110, server 200, etc.) to receive request and to provide requested data, may communicate with another vehicle(s) to exchange data for data verification, data enrichment, data correction, and the like.

Further, the sensor data may be persistently or semi-persistently stored in the vehicle 400 (e.g., store in memory 430 and/or storage component 440, etc.), for at least a predetermined period of time. In some embodiments, at least some sensor data may be transferred from vehicle 400 (e.g., via an over-the-air transmission over a network) to one or more storage mediums (e.g., a server or cloud storage, etc.). Metadata or a log of the transferred sensor data or other information indicative of the transferred data may be stored in the vehicle or implicitly known in the control logic of the vehicle. The sensor data may be captured periodically, continuously, intermittently, or based on a trigger event (e.g., a loud sound, a horn actuation, a quick deceleration or hard braking, a quick turn, etc.). Further, a portion or all of the sensor data may be processed by the processor 420 before and/or after storing to the storage medium(s). Said sensor data may be processed (e.g., pre-processed, converted, anonymized, etc.) in a similar manner described above with reference to FIG. 2, thus redundant descriptions associated therewith may be omitted below for conciseness.

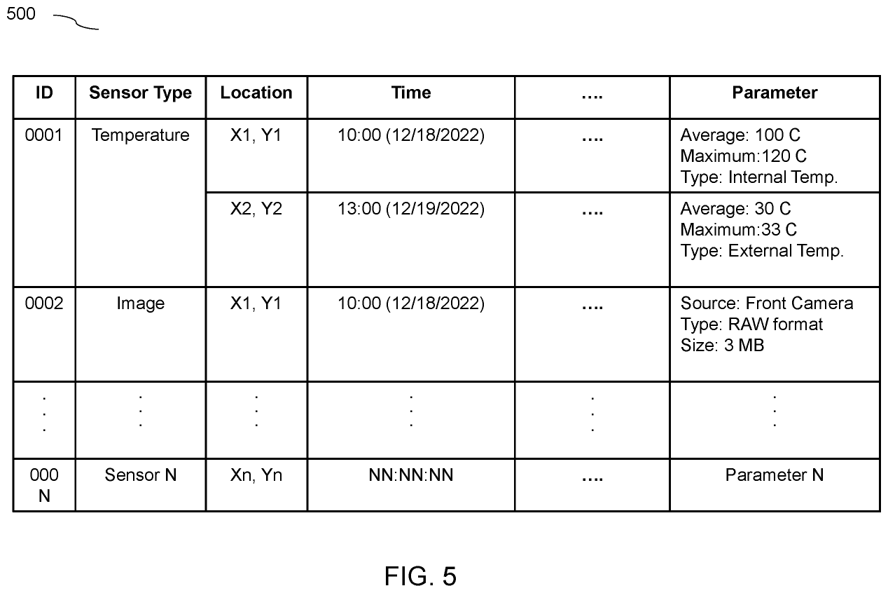

FIG. 5 illustrates an example of a record file 500, according to one or more embodiments. Record file 500 may include sensor data captured by the at least one sensor 450 in FIG. 4 and the associated information, such as location at which the data is measured and captured, time on which the data is measured and captured, parameters specific to the sensor type (e.g., temperature type, image source, etc.), and the like.

The record file 500 may be stored in the vehicle (e.g., in memory 430 and/or storage component 440, etc.), and/or may be stored in one or more devices external to the vehicle (e.g., cloud server, external storage medium, etc.). Further, it can be understood that multiple record files may be created and stored. For instance, a first record file may be created for recording sensor data provided by the temperature sensor, a second record file may be created for recording sensor data provided by the image sensor, and the like.

Further, it can also be understood that the record file may include more/less information as illustrated in FIG. 5. For instance, in the case which the sensor data (e.g., metadata, etc.) are stored in an external storage medium(s), the record file may include information of the external storage medium(s) such as access link, storage time, and the like.

According to one or more embodiments, the vehicle 400 may be configured to perform a method for providing data to one or more servers. The provided data may be utilized as evidence to investigate an event (e.g., a crime, an accident, etc.). Alternatively, the provided data may be utilized for other purposes, such as map making, historical logging, and the like.

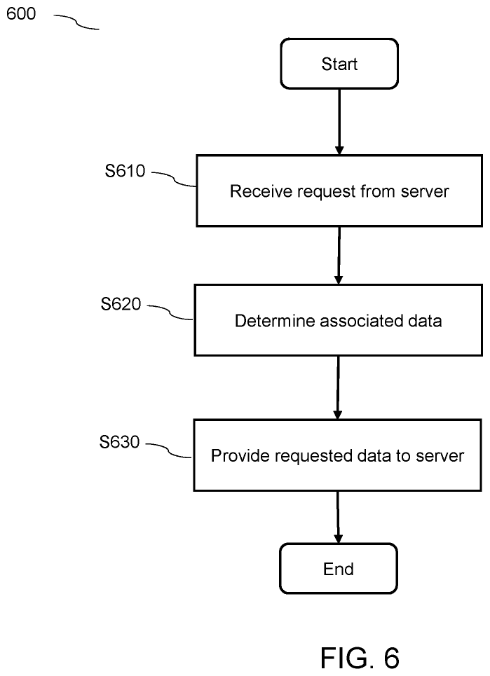

FIG. 6 illustrates a flow diagram of an example method 600 for providing data to investigate an event, according to one or more embodiments. One or more operations of method 600 may be performed by one or more processors (e.g., processor 420) in a vehicle (e.g., vehicle 130-1/vehicle 130-2 in FIG. 1, vehicle 400 in FIG. 4, etc.). For instance, the vehicle may be configured to request for event data from a server, to determine the event data associated with the request, and to provide the requested event data to the server.

Referring to FIG. 6, at operation S610, the vehicle may be configured to receive a request from a server. For instance, one or more processors of the vehicle (e.g., processor 420, etc.) may be configured to obtain or receive a request via a communication interface (e.g., communication interface 470, etc.) from a server (e.g., server 110, server 200, etc.) communicatively coupled to the vehicle via a network (e.g., network 120, etc.). According to embodiments, the request may include information associated with the event, such as a location of the event, a time of the event, a type of the event, and the like.

At operation S620, the vehicle may determine event data associated with the event. Specifically, the one or more processors of the vehicle may determine, from the request, which of the sensor data is requested or is most related to the event. For instance, the one or more processors may retrieve a record file (e.g., record file 500) and determine associated sensor data as the event data therefrom.

According to embodiments, the one or more processors of the vehicle may check the record file to determine sensor data corresponding to location information (e.g., particular latitude, particular longitude, etc.) included in the request and/or corresponding to a predetermined range or area based on the location information.

Further, the one or more processors of the vehicle may check the record file to determine sensor data corresponding to timing information (e.g., specific time point, specific date, etc.) and/or corresponding to a predetermined time range (a first predetermined period before and a second predetermined period after, where the first and second periods may be the same, the first period may be greater, or the second period may be greater in various embodiments), based on that specific time point.

Furthermore, the one or more processors of the vehicle may determine a type of event (e.g., fire incident, car accident, etc.) from the request, and may determine the type of sensor data associated with the type of event (e.g., temperature data, contact/impact data, etc.) from the record file. Alternatively, the request may include information of one or more predetermined types of sensor data (e.g., image data, audio data, etc.), and the one or more processors may simply check the record file for further details of the one or more predetermined types of sensor data. The predetermined types of sensor data may be coded into one or more programming logics.

Upon determining the event data associated with the request, at operation S630, the vehicle may be configured to provide the requested event data to the server. For instance, the one or more processors of the vehicle may retrieve the event data (e.g., sensor data associated with the event, etc.) from the storage medium (e.g., memory 430, storage component 440, etc.), and may provide the retrieved event data to the server via the communication interface thereafter.

According to embodiments, the vehicle may process (e.g., pre-process, convert, anonymize, etc.) the retrieved event data, and then transmit the processed event data to the server. According to other embodiments, the vehicle may transmit the retrieved event data to one or more devices (e.g., server, computer, etc.) configured to process the retrieved event data, before forwarding the event data to the server. Alternatively, the vehicle may simply provide information of the event data (e.g., uniform resource locator (URL) link of the device storing/processing the event data, etc.) to the server, and the server may retrieve the event data based on the provided information.

In view of the above, examples embodiments of the present disclosure provides a method, a system, a device, or the like, for crowdsourcing data from a plurality of vehicles equipped with onboard sensors. Accordingly, a larger amount and more robust data may be collected. For instance, a larger amount and more trustworthy or unbiased evidence corresponding to an event or incident can be obtained, and the event/incident may be investigated and eased based thereon.

It is understood that the specific order or hierarchy of blocks in the processes/flowcharts disclosed herein is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

Some embodiments may relate to a system, a method, and/or a computer-readable medium at any possible technical detail level of integration. Further, one or more of the above components described above may be implemented as instructions stored on a computer readable medium and executable by at least one processor (and/or may include at least one processor). The computer-readable medium may include a computer-readable non-transitory storage medium (or media) having computer-readable program instructions thereon for causing a processor to carry out operations.

The computer readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object-oriented programming languages such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or another device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer-readable media according to various embodiments. In this regard, each block in the flowchart or block diagrams may represent a module, segment, or portion of instructions, which comprises one or more executable instructions for implementing the specified logical function(s). The method, computer system, and computer-readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software.

The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

What is claimed is:

1. A method, implemented by programmed one or more processors in a server, for collecting evidence to investigate an event, the method comprising:
obtaining a time and a location for the event to be investigated;
transmitting a signal including the time and the location for requesting sensor data corresponding to the event from a plurality of vehicles;
receiving the sensor data corresponding to the event from at least one of the plurality of vehicles; and
providing the received sensor data for investigating the event.

2. The method according to claim 1, wherein the time comprises a time range corresponding to the event and/or the location comprises a location range corresponding to the event.

3. The method according to claim 1, wherein the sensor data comprises at least one of image data, LiDAR sensor data, accelerometer data, audio data, and infrared image data captured by onboard sensors of the vehicle.

4. The method according to claim 1, wherein the receiving the sensor data comprises receiving the sensor data from another server that anonymizes the sensor data.

5. The method according to claim 1, further comprising:
processing the received sensor data,
wherein the received sensor data comprises infrared image data, and
wherein the processing the received sensor data comprises determining whether the infrared image data includes a shape of an object with a temperature greater than a predetermined threshold.

6. The method according to claim 1, further comprising:
processing the received sensor data,
wherein the received sensor data comprises LiDAR sensor data, and
wherein the processing the received sensor data comprises determining whether the event is captured based on the LiDAR sensor data.

7. The method according to claim 1, further comprising:
performing, on the received sensor data, one or more of: pre-processing, converting, collating, and filtering.

8. A system for collecting evidence to investigate an event, the system comprising:
a memory storing instructions; and
at least one programmed processor configured to execute the instructions to:
obtain a time and a location for the event to be investigated;
transmit a signal including the time and the location for requesting sensor data corresponding to the event from a plurality of vehicles;
receive the sensor data corresponding to the event from at least one of the plurality of vehicles; and
provide the received sensor data for investigating the event.

9. The system according to claim 8, wherein the time comprises a time range corresponding to the event and/or the location comprises a location range corresponding to the event.

10. The system according to claim 8, wherein the sensor data comprises at least one of image data, LiDAR sensor data, accelerometer data, audio data, and infrared image data captured by onboard sensors of the vehicle.

11. The system according to claim 8, wherein the receiving the sensor data comprises receiving the sensor data from another server that anonymizes the sensor data.

12. The system according to claim 8, wherein the at least one programmed processor is further configured to execute the instructions to:
process the received sensor data,
wherein the received sensor data comprises infrared image data, and
wherein the processing the received sensor data comprises determining whether the infrared image data includes a shape of an object with a temperature greater than a predetermined threshold.

13. The system according to claim 8, wherein the at least one programmed processor is further configured to execute the instructions to:
process the received sensor data,
wherein the received sensor data comprises LiDAR sensor data, and
wherein the processing the received sensor data comprises determining whether the event is captured based on the LiDAR sensor data.

14. The system according to claim 8, wherein the at least one programmed processor is further configured to execute the instructions to perform, on the received sensor data, one or more of: pre-processing, converting, collating, and filtering.

15. A non-transitory computer-readable recording medium having recorded thereon instructions executable by at least one programmed processor to cause the at least one programmed processor to perform a method for collecting evidence to investigate an event, the method comprising:
obtaining a time and a location for the event to be investigated;
transmitting a signal including the time and the location for requesting sensor data corresponding to the event from a plurality of vehicles;
receiving the sensor data corresponding to the event from at least one of the plurality of vehicles; and
providing the received sensor data for investigating the event.

16. The non-transitory computer-readable recording medium according to claim 15, wherein the time comprises a time range corresponding to the event and/or the location comprises a location range corresponding to the event.

17. The non-transitory computer-readable recording medium according to claim 15, wherein the sensor data comprises at least one of image data, LiDAR sensor data, accelerometer data, audio data, and infrared image data captured by onboard sensors of the vehicle.

18. The non-transitory computer-readable recording medium according to claim 15, wherein the receiving the sensor data comprises receiving the sensor data from another server that anonymizes the sensor data.

19. The non-transitory computer-readable recording medium according to claim 15, wherein the method further comprising:
processing the received sensor data,
wherein the received sensor data comprises infrared image data, and
wherein the processing the received sensor data comprises determining whether the infrared image data includes a shape of an object with a temperature greater than a predetermined threshold.

20. The non-transitory computer-readable recording medium according to claim 15, wherein the method further comprising:
processing the received sensor data,
wherein the received sensor data comprises LiDAR sensor data, and
wherein the processing the received sensor data comprises determining whether the event is captured based on the LiDAR sensor data.
